(19) United States
(12) Patent Application Publication
(10) Pub. No.: US 2006/0055927 A1
(43) Pub. Date: Mar. 16, 2006

(54) Turbidity sensor

(75) Inventor: Chang Dong Feng, Long Beach, CA (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Rosemount Analytical Inc., Irvine, CA (US)

(21) Appl. No.: 11/215,608

(22) Filed: Aug. 29, 2005

Related U.S. Application Data
(60) Provisional application No. 60/610,487, filed on Sep. 16, 2004.

(51) Int. Cl. G01N 21/00

(52) U.S. Cl. 356/338

(57) ABSTRACT

A sensor for sensing turbidity of a liquid sample includes an illumination source, a scattered illumination detector, and a transparent, hydrophilic layer. The illumination source directs incident illumination into the liquid sample without passing through a gas. The scattered illumination detector is disposed to detect at least some illumination scattered in the sample. The transparent, hydrophilic layer is interposed between the source and the liquid sample, and interposed between the detector and the liquid sample. The transparent, hydrophilic layer inhibits bubble formation within the liquid sample proximate at least the incident illumination. A method for sensing turbidity is also disclosed.

### CROSS-REFERENCE TO CO-PENDING APPLICATION

The present application is based on and claims the benefit of U.S. provisional patent application Ser. No. 60/610,487, filed Sep. 16, 2004, the content of which is hereby incorporated by reference in its entirety.

### BACKGROUND OF THE INVENTION

The present invention relates to turbidity sensors.

Turbidity sensors essentially measure the “cloudiness” of a fluid such as water. This measurement is generally done by directing one or more beams of light, either visible or invisible, into the fluid and detecting the degree to which light is scattered off of solid particles suspended in the fluid solution. The resulting turbidity measurement is generally given in Nephelometric Turbidity Units (NTU).

Turbidity measurement systems are used in a wide array of applications including water and waste water monitoring, food and beverage processing, filtration processes, biological sludge control, water quality measurement and management, final effluent monitoring, and even devices such as dishwashers and washing machines.

### SUMMARY OF THE INVENTION

A sensor for sensing turbidity of a liquid sample includes an illumination source, a scattered illumination detector, and a transparent, hydrophilic layer. The illumination source directs incident illumination into the liquid sample without passing through a gas. The scattered illumination detector is disposed to detect at least some illumination scattered in the sample. The transparent, hydrophilic layer is interposed between the source and the liquid sample, and interposed between the detector and the liquid sample. The transparent, hydrophilic layer inhibits bubble formation within the liquid sample proximate at least the incident illumination. A method for sensing turbidity is also disclosed.

### BRIEF DESCRIPTION OF THE DRAWINGS

FIG. 1 is a diagrammatic view of a turbidity sensing system with which embodiments of the present invention are particularly useful.

FIG. 2 is a diagrammatic view illustrating basic design of optical turbidity sensors.

FIG. 3 is a diagrammatic view of a turbidity sensor in accordance with the prior art.

FIG. 4 is a diagrammatic view of another turbidity sensor in accordance with the prior art.

FIG. 5 is a diagrammatic view of a turbidity sensor in accordance with an embodiment of the present invention.

FIG. 6 is a diagrammatic view of a turbidity sensor in accordance with another embodiment of the present invention.

### DETAILED DESCRIPTION OF THE PREFERRED EMBODIMENTS

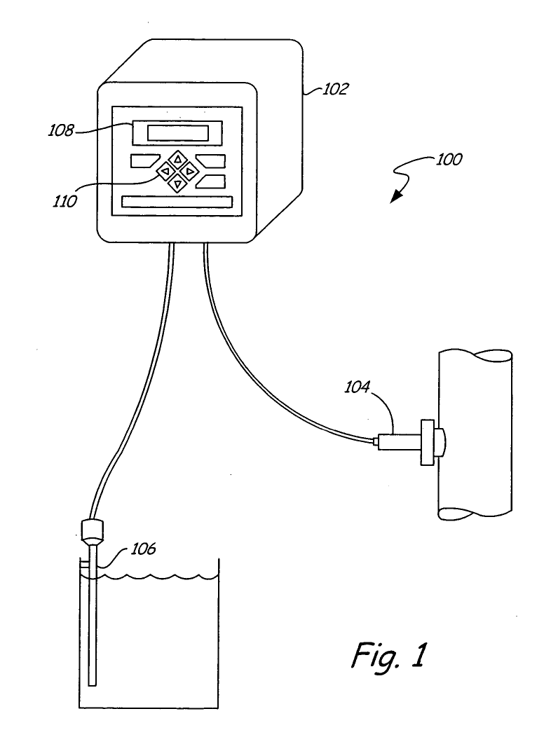

FIG. 1 is a diagrammatic view of turbidity sensing system 100 with which embodiments of the present invention are particularly useful. System 100 includes a turbidity analyzer or meter 102 coupled to one or more turbidity sensors 104, 106. Turbidity sensors may be any suitable types of turbidity sensors including an insertion-type turbidity sensor 104, and/or a submersion-type sensor 106. Further, any type of electromagnetic radiation may be used as illumination for the turbidity sensors. For example, sensors in compliance with U.S. EPA regulation 180.1 that use visible light can be used. Additionally, sensors in accordance with ISO 7027, which use near infrared LEDs may also be employed. However, it is preferred that the illumination be a structured beam of monochromatic light, such as a laser.

Analyzer 102 preferably includes an output 108 in the form of a display. Additionally, or alternatively, analyzer 102 may have a communication output providing the turbidity readings to an external device. Analyzer 102 also preferably includes a user input in the form of one or more buttons 110. However any suitable input can be used. In fact, analyzer 102 may receive input via a communication interface.

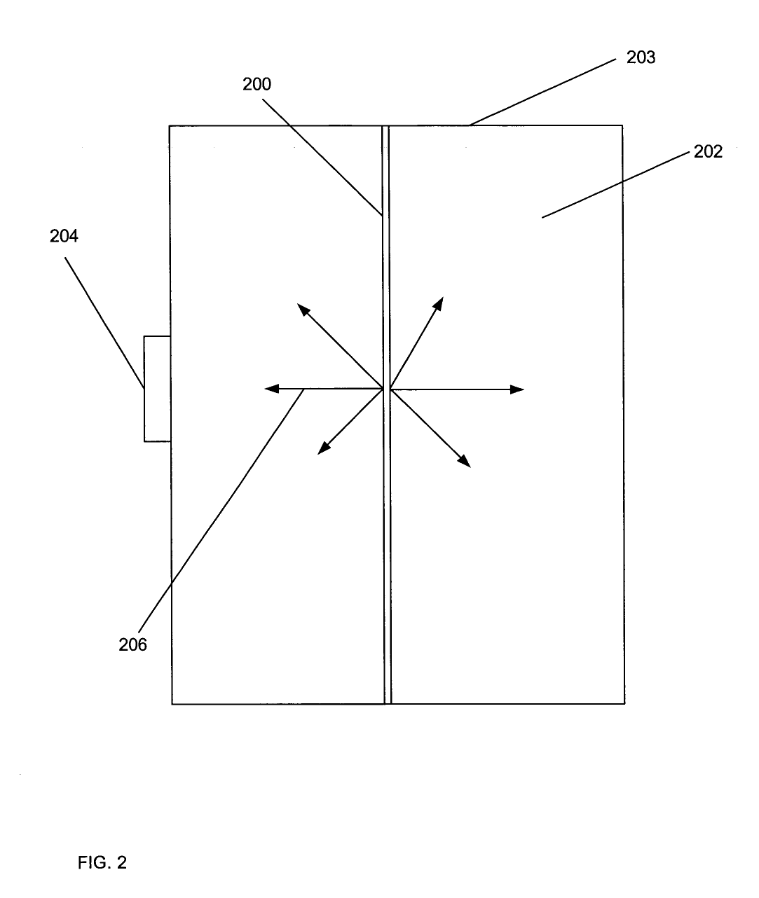

FIG. 2 is a diagrammatic view illustrating basic design of optical turbidity sensors. Generally, a beam 200 of incident illumination is directed through liquid sample 202 within a sample chamber or vessel 203. As beam 200 passes through sample 202, beam 200 collides with particulate matter, such as suspended solids, disposed within sample 202. As a result of the various collisions, a portion of illumination 200 is scattered in various directions, depending on individual collisions. Accordingly, an indication of turbidity is often generated by measuring the degree to which beam 200 is scattered. Thus, disposing scattered light detector 204 at an angle and position such that only some of the scattered illumination 206 is received by detector 204 allows detector 204 to provide a direct indication of turbidity. This scattering of light passing through a liquid sample forms the basis of many optical turbidity sensors in use today. For better results, modern optical turbidity sensors often position scattered light detector 204 at an approximate 90-degree angle relative to incident light beam 200. The turbidity sensor output can then be a simple indication of the relative ratio between the intensity of incident beam 200 and intensity of scatter beam 206 measured by detector 204.

Embodiments of the present invention have been developed based upon extensive testing of modern optical turbidity sensors and their limitations. In order to appreciate the synergy created by embodiments of the present invention, it is first beneficial to examine two common types of optical turbidity sensors and their respective limitations.

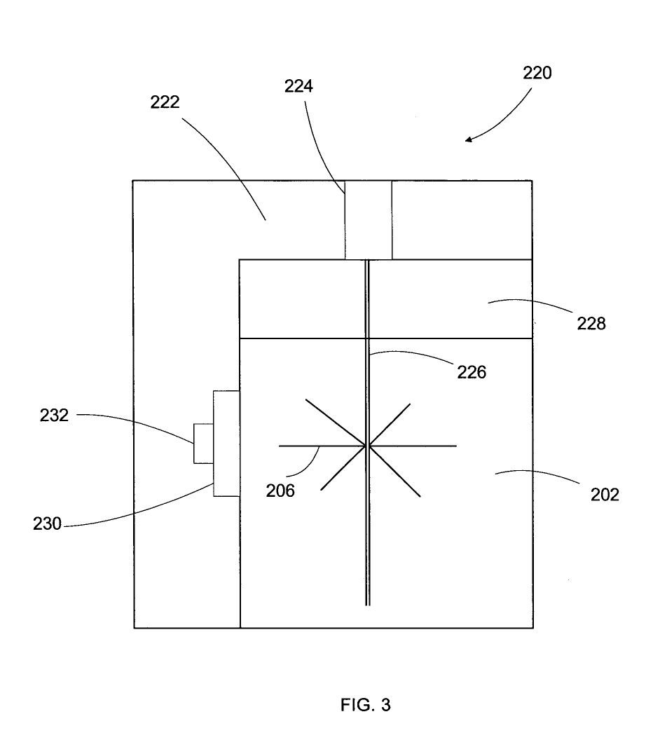

FIG. 3 is a diagrammatic view of a turbidity sensor in accordance with the prior art. Sensor 220 includes sensor body 222, a portion of which is shown in FIG. 3. Sensor body 222 is configured to contain, or otherwise contact, sample 202. Incident light source 224 directs an incident beam 226 downwardly through air space 228 and into sample 202. As described above, incident beam 226 will collide with solids, or other particles, within sample 202, and some of the illumination in incident beam 226 will be deflected. Some of the deflected illumination, illustrated as deflected beam 206 will pass through glass window 230 and be detected by detector 232. This particular design is known to provide very stable turbidity readings, but it is susceptible to errors when subjected to vibrations. Given that many industrial and/or research environments may have generate significant vibrations, this is a significant limitation. It is believed that the vibration susceptibility stems from air space 228 between light source 224 and sample 202.

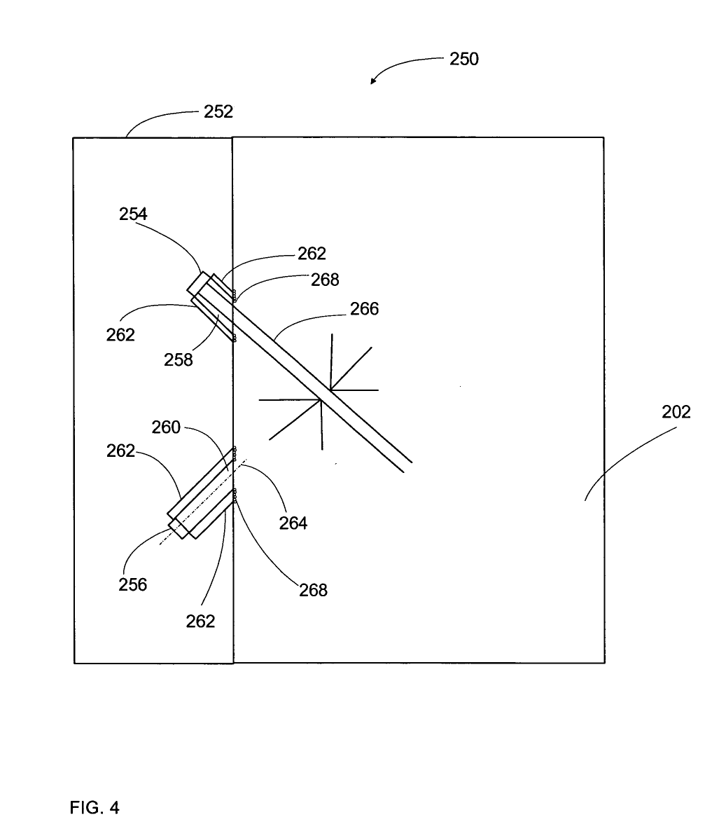

FIG. 4 is a diagrammatic view of another turbidity sensor in accordance with the prior art. Sensor 250 includes sensor body 252, which may be plastic or metal, that is configured to contact liquid sample 202. Sensor body 252 can be a chamber constructed to contain a quantity of sample liquid 202, or sensor body can simply be configured to be submersed in, or otherwise contacted with, liquid sample 202. Sensor body 252 contains incident light source 254 and scattered light detector 256. Each of source 254 and detector 256 are optically coupled with the sample liquid by virtue of lens/windows 258, 260 respectively. Incident light source 254 and lens 258 are mounted within sensor body 252 using adhesive 262. Similarly, detector 256 and lens 260 are mounted in sensor body 252 using adhesive 262. As illustrated, source 254 and detector 256 are generally arranged such that detector 256 has an optical axis 264 that is substantially perpendicular to source beam 266 from source 254.

It has been observed that sensor 250 is not generally as stable as sensor 220 described with respect to FIG. 3. However, sensor 250 is substantially immune to vibration. Thus, in environments where vibration is likely to occur, a turbidity sensor such as sensor 250 would need to be used. Evaluation test results indicate that much of the instability of sensor 250 is caused by the formation of small bubbles 268 where the adhesive comes into contact with the liquid sample. Bubbles 268 can interact with incident beam 266, or any scattered illumination. Any illumination that is diverted from incident beam 266 by one or more bubbles 268 will cause errors. Similarly, any of the illumination from incident beam 266 that actually collides with a solid, and is later thwarted from being detected by detector 256 by contacting one or more bubbles will also generate errors.

Thus, evaluation test results of both types of currently available optical turbidity sensors indicate that each sensor has strengths and limitations. Embodiments of the present invention employ features from various types of turbidity sensors by combining such design features based upon a careful and detailed evaluation of prior sensors.

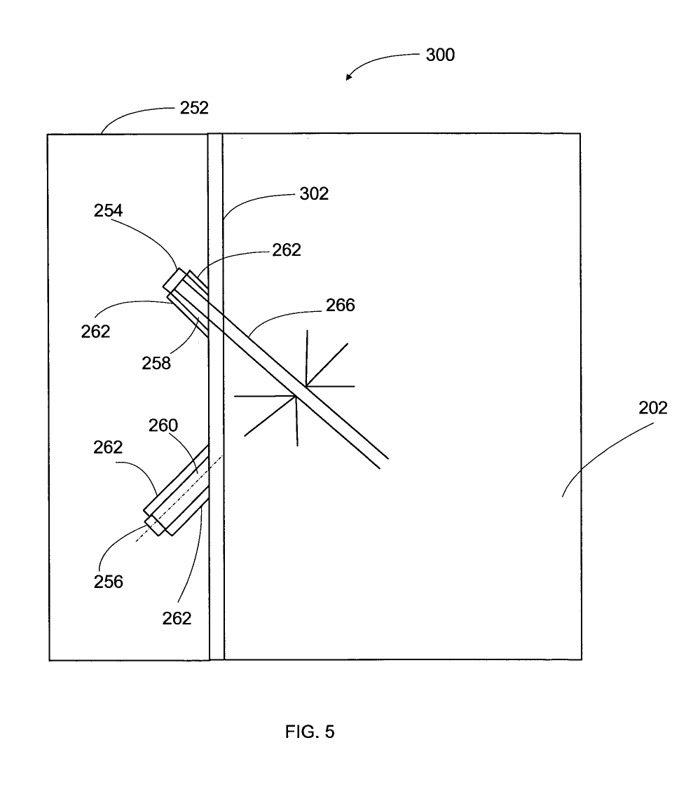

FIG. 5 is a diagrammatic view of a turbidity sensor in accordance with an embodiment of the present invention. Sensor 300 is similar to sensor 250 and like components are numbered similarly. Sensor 300 includes source 254 and detector 256 disposed within sensor body 252 using an adhesive 262. However, adhesive 262 is not in contact with liquid sample 202. Layer 302 is substantially planar. Instead, a transparent, hydrophilic layer 302 is disposed between liquid sample 202 and adhesive 262. Due to the hydrophilic nature of layer 302, no bubbles form proximate adhesive 262. Thus, sensor 300 provides the vibration immunity of sensor 250, but has improved stability over sensor 250 due to the absence of any bubbles proximate incident beam 266 or any of the scattered illumination. Layer 302 can be made of any transparent, hydrophilic material including glass. Further, layer 302 can be attached by using adhesive, such as adhesive 262, or by integrating layer 302 into windows/lenses 258 and 260. Finally, layer 302 can also be deposited on the sensor surface through thick film or thin film technology.

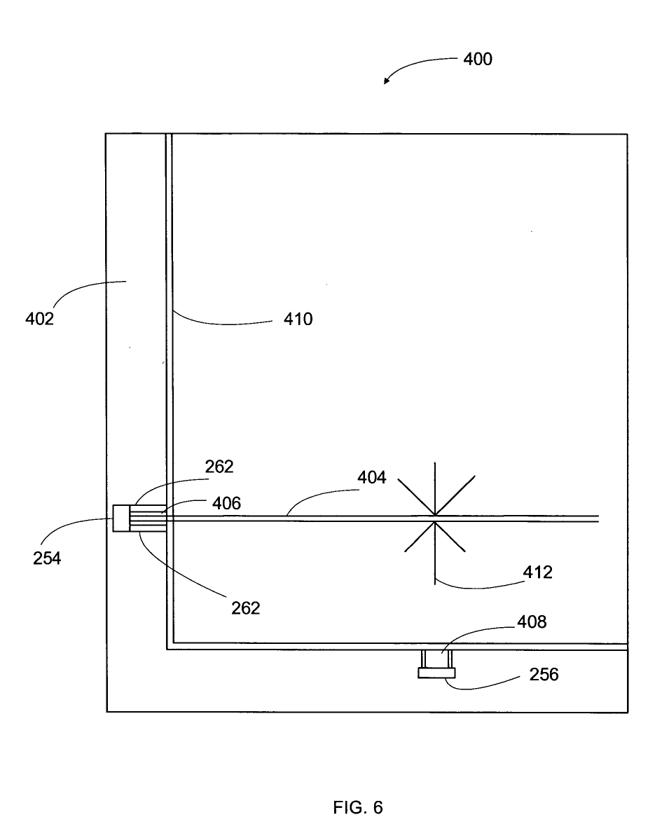

FIG. 6 is a diagrammatic view of a turbidity sensor in accordance with another embodiment of the present invention. Sensor 400 includes sensor body 402 that is configured to contain, or otherwise contact, liquid sample 202. Source 254 is mounted within sensor body 402 by adhesive 262 and directs a beam 404 through lens 406 into liquid sample 202. Similarly, detector 256 and lens 408 are mounted within or adjacent to sensor body 402 using adhesive 262. Sensor 400 includes transparent, hydrophilic layer 410 through which incident beam 404 and scattered beam 412 pass. Layer 410 need not be continuous, but should extend substantially beyond the regions proximate source 254 and detector 256. That way, any bubbles that may form at discontinuities will be away from incident beam 404 and scattered beam 412. Additionally, layer 410, while described as transparent, need only be transparent to illumination of the wavelength of beam 404. Thus, as used herein, transparent is intended to a feature wherein the material will at least able to pass illumination of the wavelength(s) of the incident beam.

Those skilled in the art will appreciate that problems of the prior art have been solved with embodiments of the present invention. Vibration immunity is maintained since the incident beam does not pass through any gas, such as air. Moreover, sensor stability is increased due to the elimination of bubbles proximate the illumination.

While specific electronic circuits have not been disclosed relative to the turbidity sensors described herein, it is noted that any suitable, commercially available technology may be used to drive the illuminator and/or generate illumination detection via detectors.

Although the present invention has been described with reference to preferred embodiments, workers skilled in the art will recognize that changes may be made in form and detail without departing from the spirit and scope of the invention.

What is claimed is:

1. A sensor for sensing turbidity of a liquid sample, the sensor comprising:
an illumination source direct incident illumination into the liquid sample without passing through a gas;
a scattered illumination detector disposed to detect at least some illumination scattered in the sample; and
a transparent, hydrophilic layer interposed between the source and the liquid sample, and interposed between the detector and the liquid sample; and
wherein the transparent, hydrophilic layer inhibits bubble formation within the liquid sample proximate at least the incident illumination.

2. The sensor of claim 1, wherein the transparent, hydrophilic layer is continuous.

3. The sensor of claim 1, wherein the transparent, hydrophilic layer is constructed from glass.

4. The sensor of claim 1, wherein the transparent, hydrophilic layer is substantially planar.

5. The sensor of claim 1, wherein the transparent, hydrophilic layer is deposited using thick film technology.

6. The sensor of claim 1, wherein the transparent, hydrophilic layer is deposited using thin film technology.

7. The sensor of claim 1, and further comprising a sensor body containing the illumination source and the detector.

8. The sensor of claim 7, wherein the illumination source is mounted within the sensor body with adhesive.

9. The sensor of claim 8, wherein the transparent, hydrophilic layer is interposed between the adhesive and the liquid sample.

10. The sensor of claim 7, wherein the detector is mounted within the sensor body with adhesive.

11. The sensor of claim 10, wherein the transparent, hydrophilic layer is interposed between the adhesive and the liquid sample.

12. The sensor of claim 1, wherein the illumination source is a laser light source.

13. A method of measuring turbidity, the method comprising;
generating a beam of illumination;
directing the beam into a liquid sample without passing the beam through any gas;
measuring at least some scattered illumination within the liquid sample; and
ensuring that bubbles do not interact with the beam.

14. The method of claim 13, wherein ensuring that bubbles do not interact with either the beam or the scattered illumination includes providing a transparent, hydrophilic layer proximate a source of the beam.

15. The method of claim 14, and further comprising providing the transparent, hydrophilic layer proximate a detector of scattered illumination.
